(19) United States
(12) Patent Application Publication
(10) Pub. No.: US 2010/0187326 A1
(43) Pub. Date: Jul. 29, 2010

(54) Waterfall Unit

(75) Inventors: Garo Paroonagian, Upland, CA (US); Mario S. Pakingan, Buena Park, CA (US)

Correspondence Address: THE WEBB LAW FIRM, P.C., 700 KOPPERS BUILDING, 436 SEVENTH AVENUE, PITTSBURGH, PA, 15219, US

(73) Assignee: JACUZZI INC., Chino, CA (US)

(21) Appl. No.: 12/689,074

(22) Filed: Jan. 18, 2010

Related U.S. Application Data
(60) Provisional application No. 61/146,801, filed on Jan. 23, 2009.

(51) Int. Cl. B05B 17/08

(52) U.S. Cl. 239/17

(57) ABSTRACT

A waterfall unit for supplying a laminar flow of water into a water containment device. The waterfall unit comprising a fill spout having a water inlet for receiving water from a water source, a plenum chamber for containing an amount of water, and an elongated fill spout water outlet for expelling the water. A cover is provided for encasing at least a portion of the fill spout. The cover includes an elongated water outlet in alignment with the fill spout outlet. The waterfall unit also includes an enclosure member for enclosing the fill spout and the cover member to form a unit adapted for mounting onto a ledge of the water containment device. A related method for retrofitting a waterfall unit onto a water containment device is also provided.

### CROSS-REFERENCE TO RELATED APPLICATIONS

This application claims the benefit of U.S. Provisional Patent Application No. 61/146,801, entitled “Waterfall Unit”, filed Jan. 23, 2009; which is herein incorporated by reference in their entirety.

### BACKGROUND OF THE INVENTION

1. Field of the Invention

This invention relates to a water faucet for supplying a flow of water into a water containment device. More specifically, the invention relates to an aesthetically pleasing waterfall unit for supplying a laminar flow of water into water containment devices such as bathtubs, spas, hot tubs, and whirlpools.

2. Description of Related Art

In general, bathtubs have one traditional faucet for delivering a combination of hot and cold water or two traditional faucets for delivering hot and cold water separately into the tub. One faucet designer, such as the Assignee of the present invention, i.e., Jacuzzi, Inc. has recently developed a faucet available commercially under the trademark Water Rainbow® fill spout which includes an elongated, relatively flat faucet designed to deliver a laminar flow of water in waterfall form into a water containment device such as a bathtub, spa, hot tub or whirlpool used for hydrotherapy baths. More sophisticated buyers or users of tubs and/or spas are continually looking for more aesthetically appealing bathroom accessories for enhancing the experience in a hydrotherapy bath, for example, the massaging effect of the bathroom accessories, e.g., spa jets, nozzles and faucets, for delivering water in various forms into the water containments of hydrotherapy baths. Some of these same sophisticated buyers or users are also looking for more aesthetically appealing accessories for enhancing the appearance of the tubs and/or spas.

There is a need, therefore, in the art for a waterfall unit which delivers a waterfall into a bathtub and which waterfall unit is aesthetically pleasing. There is also a need for a waterfall unit that can be easily retrofitted onto existing bathtubs.

### SUMMARY OF THE INVENTION

According to one aspect, the present invention is directed to a waterfall unit for supplying a laminar flow of water into a water containment device. The waterfall unit comprises a fill spout having a water inlet for receiving water from a water source, a plenum chamber for containing an amount of water, and an elongated fill spout water outlet for expelling the water. A cover is provided for encasing at least a portion of the fill spout. The cover includes an elongated water outlet in alignment with the fill spout outlet. The waterfall unit also includes an enclosure member for enclosing the fill spout and the cover member to form a unit adapted for mounting onto a ledge of the water containment device. According to one embodiment, the enclosure member is a shell, such as an acrylic shell, comprising a base, a first leg and a second leg, wherein the first leg and second leg extend from opposite sides of the base. The first leg includes an opening extending therethrough which is in alignment with the water outlets of the fill spout and the cover. According to one design, the first leg is longer in length than the second leg and the first and second legs straddle the ledge of the water containment device. The cover includes an upper cover member and a lower cover member configured for holding the fill spout therebetween. The lower cover member can include a cut-out portion configured for accommodating the plenum chamber. A cover face plate can be located adjacent to the water outlet of the cover. The waterfall unit also includes a mounting system for mounting the unit to the water containment device. According to one embodiment, the mounting system includes a cleat positioned adjacent to an inner surface of the enclosure member and an adjustable bracket for mounting the cleat with respect to the fill spout. The cleat can have an inclined surface configured for contacting an inclined inner surface of the enclosure member. The cleat can have a length substantially equal to a length of the enclosure member. The elongated fill spout water outlet of the waterfall unit is configured for delivering water in a waterfall form and at least one water faucet control is provided for delivering and interrupting the flow of water in the fill spout.

According to another aspect, the present invention is directed to a method for retrofitting a water containment device with a waterfall unit for delivering a laminar flow of water into the water containment device. The method includes providing a waterfall unit comprising a fill spout having a water inlet for receiving water from a water source, a plenum chamber for containing an amount of water, and an elongated fill spout water outlet for expelling the water; a cover for encasing at least a portion of the fill spout, the cover including an elongated water outlet in alignment with the fill spout outlet; and an enclosure member for enclosing the fill spout and the cover member to form a unit adapted for mounting onto a ledge of the water enclosure. The method further includes mounting the waterfall unit onto the ledge of the water containment device and providing at least one water faucet control for delivering and interrupting the flow of water in the fill spout and connecting the at least one water faucet control to the waterfall unit. According to one embodiment, the cover comprises an upper cover member and a lower cover member configured for holding the fill spout therebetween wherein the lower cover member can include a cut-out portion configured for accommodating the plenum chamber. The enclosure member is a shell, such as an acrylic shell, comprising a base, a first leg and a second leg. The first and second legs extend from opposite sides of the base. According to one design, the first leg has a length greater than the second leg and the first leg includes an opening extending therethrough in alignment with the water outlets of both the fill spout and the cover. The mounting system comprises a cleat positioned adjacent to an inner surface of the enclosure member and an adjustable bracket for mounting the cleat with respect to the fill spout.

According to another aspect, the invention is directed to a cover for containing a fill spout assembly wherein the fill spout assembly is configured for supplying a laminar flow of water into a water containment device. The cover comprises an upper cover member; a lower cover member including a cut-out portion configured for accommodating a plenum chamber; an elongated opening defined by the upper cover member and the lower cover member wherein the elongated opening is configured for cooperation with an opening of the fill spout assembly; and securing members for securing the upper cover member and the lower cover member together to form an enclosure configured for holding the fill spout therein. The cover can include a cover face plate for covering the elongated opening defined by the upper cover member and the lower cover member.

These and other features and characteristics of the present invention, as well as the methods of operation and functions of the related elements of structures and the combination of parts and economies of manufacture, will become more apparent upon consideration of the following description with reference to the accompanying drawings, all of which form a part of this specification, wherein like reference numerals designate corresponding parts in the various figures.

### BRIEF DESCRIPTION OF THE DRAWINGS

FIG. 1 is a front perspective view illustrating the waterfall unit of the present invention;

FIG. 2 is an exploded perspective view illustrating the waterfall unit of FIG. 1;

FIG. 3 is an exploded perspective view illustrating the cover and fill spout of the waterfall unit of FIG. 2;

FIG. 4A is a cross-section view illustrating the waterfall unit of FIG. 1 and its assemblage on a water containment device;

FIG. 4B is a cross-section view of the cleat shown in FIG. 4a;

FIG. 4C is a side view of the bracket shown in FIG. 4a;

FIG. 5A is a top plan view of an upper cover member of a cover of the fill spout assembly of FIG. 2;

FIG. 5B is a front view of the upper cover member of FIG. 5a;

FIG. 5C is a bottom plan view of the upper cover member of FIG. 5a;

FIG. 5D is a perspective view of the upper cover member of FIG. 5a;

FIG. 5E is an enlarged section view taken along lines 5E-5E of FIG. 5c;

FIG. 5F is an enlarged section view taken along lines 5F-5F of FIG. 5c;

FIG. 6A is a bottom plan view of the lower cover member of the cover of the fill spout assembly of FIG. 2;

FIG. 6B is an enlarged section view taken along lines 6B-6B of FIG. 6a; and

FIG. 6C is an enlarged section view taken along lines 6C-6C of FIG. 6a.

### DETAILED DESCRIPTION OF THE INVENTION

For purposes of the description hereinafter, spatial or directional terms shall relate to the invention as it is oriented in the drawing figures. However, it is to be understood that the invention may assume various alternative variations, except where expressly specified to the contrary. It is also to be understood that the specific components illustrated in the attached drawings, and described in the following specification, are simply exemplary embodiments of the invention. Hence, specific dimensions and other physical characteristics related to the embodiments disclosed herein are not to be considered as limiting.

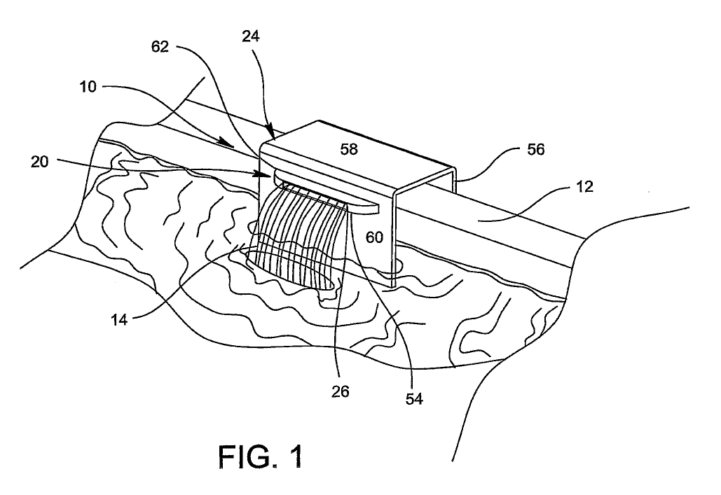

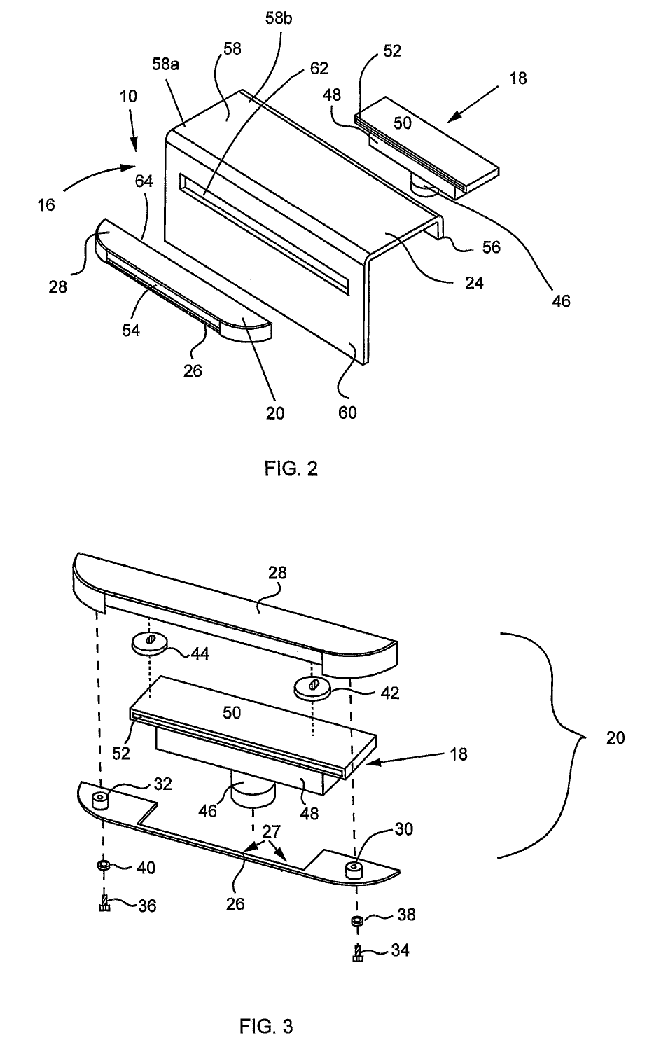

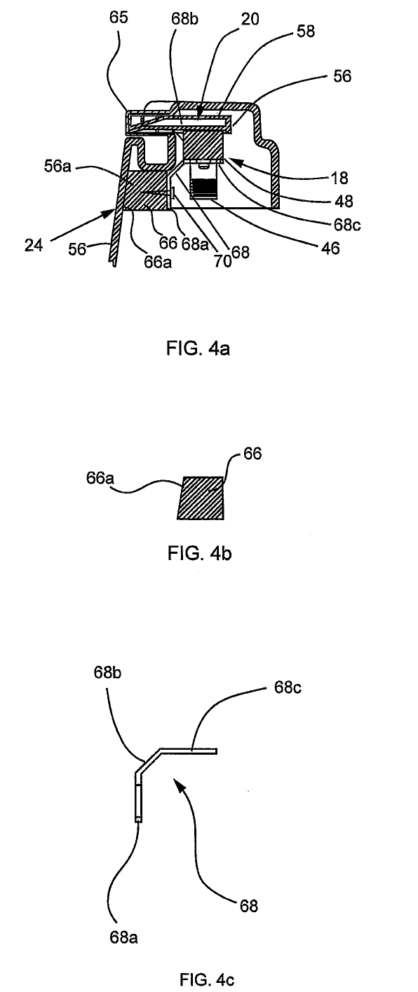

Reference is now made to FIG. 1 which illustrates a waterfall unit, generally indicated as 10, mounted over a ledge 12 of a water containment device 13 for supplying a laminar flow of water, such as a waterfall 14, into the water containment device 13. As shown in FIG. 2, the waterfall unit 12 comprises a fill spout assembly, generally indicated as 16, including a fill spout 18 having a water inlet 46 for receiving water from a water source (not shown), a plenum chamber 48 for containing an amount of water, and an elongated fill spout water outlet 52 for expelling the water. A cover 20, as shown in FIG. 3, is provided for encasing at least a portion of the fill spout 18. The cover includes an elongated water outlet 54 in alignment with the fill spout outlet 52. The waterfall unit 10 also includes an enclosure member 24 for enclosing the fill spout 18 and the cover member 20 to form a unit adapted for mounting onto the ledge 12 of the water containment device 13.

With continuing reference to FIG. 2, according to one embodiment, the enclosure member 24 is an acrylic shell which can have the shape of an inverted J-shaped member comprising a base 58, a first leg 56 and a second leg 60 wherein the first leg 56 and second leg 60 extend from opposite sides 58a, 58b of the base 58. The first leg 56 includes an elongated opening 62 extending therethrough which is in alignment with the water outlets 52, 54 of the fill spout 18 and the cover 20. According to one design, the first leg 56 is longer in length than the second leg 60 and the first and second legs 56, 60 straddle the ledge 12 of the water containment device 13.

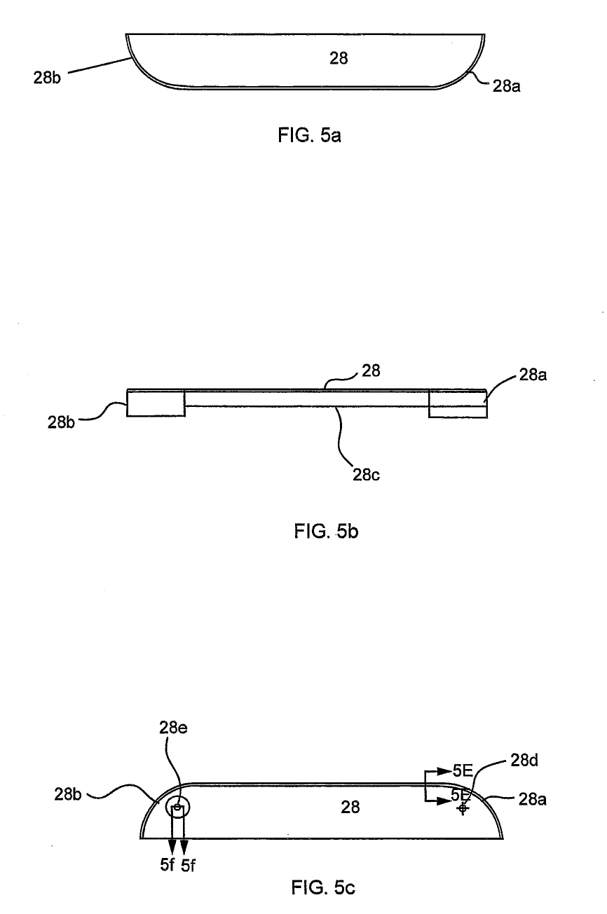

With continuing reference to FIG. 3, the cover 20 includes an upper cover member 28 and a lower cover member 26 configured for holding the fill spout 18 therebetween. The lower cover member 26 can include a cut-out portion 27 configured for accommodating the plenum chamber 48. A cover face plate 65, as shown in FIG. 4A, can be located adjacent to the water outlet 54 of the cover. Lower cover member 26 and upper cover member 28 are spaced apart by spacer members 30, 32 which are an integral part of lower cover member 26. Lower cover member 26 and upper cover member 28 are secured together via fastening means, for example, hex screws 34 and 36 and nylon spacers 38 and 40, about which more will be discussed herein below. Still referring to FIG. 3, gaskets 42 and 44 are also provided. As can be appreciated, water faucet controls for waterfall unit 10 are also provided even though not shown in the figures. As shown in FIG. 2, when lower cover member 26 and upper cover member 28 are secured together, they form an elongated water outlet 54 which is in fluid communication with the elongated water outlet 52 of fill spout 18.

As can be appreciated from FIG. 2, fill spout 18 and cover 20 are brought together and carried by the enclosure member 24. That is, fill spout 18 is inserted beneath base 58 of enclosure member 24 and its front end is slid through the elongated opening 62 of leg 60 and into a rear opening 64 formed by upper cover member 28 and lower cover member 26. A cover plate 65 is then placed over the fill spout 18 as shown in the upper left-hand area of FIG. 4a.

Referring back to FIG. 1, the elongated fill spout water outlet 52 of the waterfall unit is configured for delivering water in a waterfall form and at least one water faucet control (not shown), or a pair of faucet controls, are provided for delivering and interrupting the flow of water exiting through the fill spout 18. Referring particularly to FIGS. 2 and 3, the fill spout 18 includes a water inlet 46, a plenum chamber 48 and an elongated nozzle member 50 which has an elongated water outlet 52 for delivering a laminar flow of water in the form of a waterfall as illustrated in FIG. 1.

Referring now to FIG. 4A, the waterfall unit 10 also includes a mounting system for mounting the waterfall unit 10 to the water containment device 13. According to one embodiment, the mounting system includes a cleat 66 positioned adjacent to an inner surface 56a of the first leg 56 of enclosure member 24. An adjustable bracket 68 is provided for mounting the cleat 66 with respect to the fill spout 18. The adjustable bracket 68 is secured to the cleat 66 by any well known securing member, such as a mounting screw 70.

The cleat 66 can have an inclined or wedge surface 66a, as shown in FIG. 4b, which as shown in FIG. 4a, is configured for contacting and abutting the inclined inner surface 56a of the first leg 56 of the enclosure member 24. The cleat 66 can have a length substantially equal to a length of the enclosure member 24, thus providing full support behind the enclosure member 24. FIG. 4b illustrates more clearly the cleat 66. As shown in FIG. 4b, the cleat 66 has a wedge surface 66a which, as shown in FIG. 4a, abuts against an inner slanted surface 60a of leg 60 of enclosure member 24. Cleat 66 may be made of a material selected from the group consisting of wood, glass or ceramic, and preferably is made of wood.

FIG. 4a illustrates the manner in which enclosure member 24, with fill spout 18 and cover 20 is inserted and mounted over the ledge 12 of bathtub 13. This mounting includes a cleat 66 and adjustable bracket 68.

FIG. 4c shows a side view of the adjustable bracket 68. As shown best in FIGS. 4a and 4c, adjustable bracket 68 has a vertical section 68a, a slanted section 68b and a horizontal section 68c. As best shown in FIG. 4a, the vertical section 68a abuts against a surface of cleat 66 and receives a mounting screw 70, which also extends into the cleat 66. The slated section 68b abuts against an inner surface of enclosure member 24, and horizontal section 68c of adjustable bracket 68 abuts against an undersurface of plenum chamber 48 of fill spout 18. According to one embodiment, the adjustable bracket 68 may be made of galvanized steel and may have a thickness of about 0.06 inches.

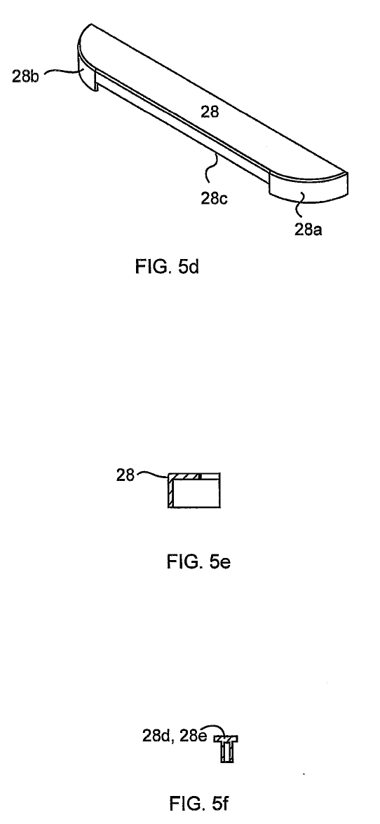

FIGS. 5a-5e illustrates the upper cover member 28 of cover 20. As shown, upper cover member 28 is an elongated member with rounded ends 28a and 28b. As shown in FIG. 5b, adjacent the rounded ends 28a and 28b is an indented section 28c, which, with the lower cover member 26 forms the opening 54 (FIG. 2) of cover 20. FIG. 5e shows the thickness of upper cover member 28, which according to one embodiment can be about 0.09 inch thick. FIG. 5f shows that holes 28d and 28e in upper cover 28 can have a diameter of about 0.20 inch and a depth of about 0.325 inch. These holes 28d and 28e receive the hex screws 34 and 36, respectively, of FIG. 3. According to one design, the rounded ends 28a and 28b of FIG. 5c can have a radius of about 2.02 inches.

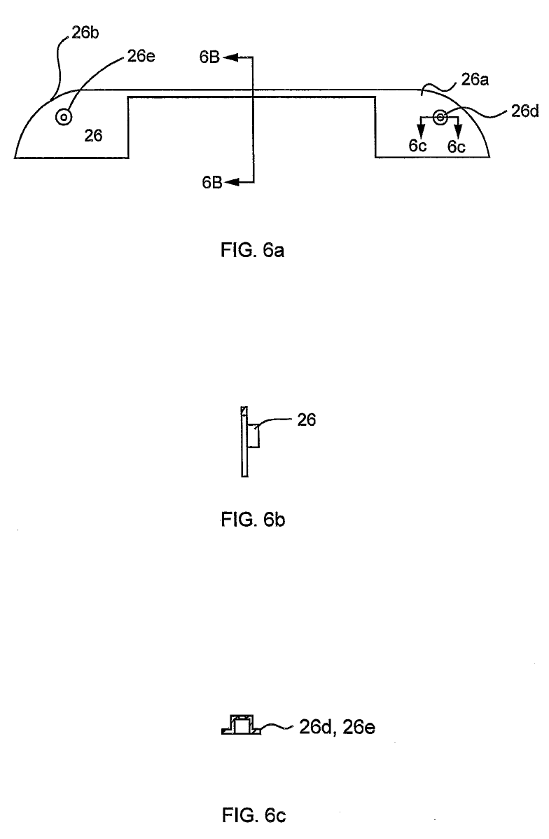

FIGS. 6a-6c illustrates the lower cover member 26 of cover 20. As shown best in FIG. 6a, lower cover member 26 is an elongated member with rounded ends 26a and 26b and an indented area 26c, which, with the upper cover member 28, forms elongated water outlet 54 (FIG. 2) of cover 20. According to one embodiment, FIG. 6b shows that the lower cover member 26 can have a thickness of about 0.09 inch and FIG. 6c shows that holes 26d and 26e in lower cover 26 can have a diameter of about 0.56 inch. These holes 26e and 26d, respectively, accommodate the spacers 30, 32, respectively, and receive the hex screws 34 and 36 of FIG. 3. FIG. 6a also shows that rounded ends 26a and 26b can have a radius of about 2.00 inches. Upper cover member 28 and lower cover member 26 may be made of a zinc alloy, such as zinc alloy SAE 903.

It is also to be appreciated that the present invention may relate to a method for retrofitting the waterfall unit 10 of FIG. 1 to the ledge 12 of bathtub 13 by providing fill spout 18, cover 20 and enclosure member 24 of FIG. 2, and using the cleat 66, adjustable bracket 68 and mounting screw 70 of FIG. 4a, and assembling these components as shown in FIG. 4a. The method also comprises providing at least one water faucet control for delivering and interrupting the flow of water in the fill spout 18 and connecting the at least one water faucet control with the waterfall unit 10 for supplying the laminar flow of water 14 into the water containment device 13.

It is also to be appreciated that the fill spout 18 may be one of the many faucets and/or covers available from Jacuzzi®, Inc. located in Chino, Calif., and the water faucet control knobs of the invention may be one of the many faucets commercially available under the trade name Jacuzzi® Water Rainbow®, as discussed hereinabove. This Jacuzzi® Water Rainbow® unit allows the waterfall unit 10 to be attached to an exterior of bathtub 13 of FIG. 1. That is, as can be appreciated, the interior arrangement, as particularly shown in FIG. 4a, allows the waterfall unit 10 to extend from the bathtub 13. The waterfall unit 10 has an appropriate size and is attached to the interior of the bathtub 13. The fill spout 18 allows laminar water flow to extend from the bathtub 13. Cover faceplate 65 (FIG. 4a) is then attached to the outward surface of bathtub 13 to permit the waterfall unit 10 to extend from the rear or front of bathtub 13.

The present invention has been described with reference to the preferred embodiments. Obvious modifications and alterations will occur to others upon reading and understanding the preceding detailed description. It is intended that the invention be construed as including all such modifications and alterations.

The invention claimed is:

1. A waterfall unit for supplying a laminar flow of water into a water containment device, said waterfall unit comprising:
a fill spout having a water inlet for receiving water from a water source, a plenum chamber for containing an amount of water, and an elongated fill spout water outlet for expelling said water;
a cover for encasing at least a portion of said fill spout, said cover including an elongated water outlet in alignment with said fill spout outlet; and
an enclosure member for enclosing the fill spout and the cover member to form a unit adapted for mounting onto a ledge of the water containment device.

2. The waterfall unit of claim 1, wherein the enclosure member is a shell comprising a base, a first leg and a second leg, said first leg and said second leg extending from opposite sides of said base.

3. The waterfall unit of claim 2, wherein said first leg includes an opening extending therethrough, said opening being in alignment with said water outlets of said fill spout and said cover.

4. The waterfall unit of claim 2, wherein said first leg is longer in length than said second leg and wherein said first and second legs straddle the ledge of the water containment device.

5. The waterfall unit of claim 1, wherein the cover includes an upper cover member and a lower cover member, said upper cover member and said lower cover member configured for holding the fill spout therebetween.

6. The waterfall unit of claim 5, wherein the lower cover member includes a cut-out portion configured for accommodating the plenum chamber.

7. The waterfall unit of claim 1, including a cover face plate located adjacent to said water outlet of said cover.

8. The waterfall unit of claim 1, including a mounting system for mounting the waterfall unit to the water containment device.

9. The waterfall unit of claim 8, wherein the mounting system includes a cleat positioned adjacent to an inner surface of said enclosure member and an adjustable bracket for mounting said cleat with respect to said fill spout.

10. The waterfall unit of claim 9, wherein the cleat has an inclined surface configured for contacting an inclined inner surface of said enclosure member.

11. The waterfall unit of claim 9, wherein said cleat has a length substantially equal to a length of the enclosure member.

12. The waterfall unit of claim 1, wherein said elongated fill spout water outlet is configured for delivering water in a waterfall form.

13. The waterfall unit of claim 1, including at least one water faucet control for delivering and interrupting the flow of water in the fill spout.

14. A method for retrofitting a water containment device with a waterfall unit for delivering a laminar flow of water into the water containment device, said method comprising:
providing a waterfall unit comprising:
(i) a fill spout having a water inlet for receiving water from a water source, a plenum chamber for containing an amount of water, and an elongated fill spout water outlet for expelling said water;
(ii) a cover for encasing at least a portion of said fill spout, said cover including an elongated water outlet in alignment with said fill spout outlet; and
(iii) an enclosure member for enclosing the fill spout and the cover member to form a unit adapted for mounting onto a ledge of the water containment device;
providing a mounting system for mounting said waterfall unit onto a ledge of said water containment device;
providing at least one water faucet control for delivering and interrupting the flow of water in the fill spout; and
connecting said at least one water faucet control with the waterfall unit for supplying the laminar flow of water into the water containment device.

15. The method of claim 14, wherein the cover comprises an upper cover member and a lower cover member configured for holding the fill spout therebetween, said lower cover member including a cut-out portion configured for accommodating the plenum chamber.

16. The method of claim 14, wherein the enclosure member is a shell comprising a base, a first leg and a second leg, said first leg and said second leg extending from opposite sides of said base.

17. The method of claim 16, wherein said first leg has a length greater than said second leg and said first leg includes an opening extending therethrough in alignment with said water outlets of said fill spout and said cover.

18. The method of claim 14, wherein the mounting system comprises a cleat positioned adjacent to an inner surface of said enclosure member and an adjustable bracket for mounting said cleat with respect to said fill spout.

19. A cover for containing a fill spout assembly, said fill spout assembly configured for supplying a laminar flow of water into a water enclosure, said cover comprising:
an upper cover member;
a lower cover member, said lower cover member including a cut-out portion configured for accommodating a plenum chamber;
an elongated opening defined by said upper cover member and said lower cover member, said elongated opening configured for cooperation with an opening of the fill spout assembly; and
securing members for securing said upper cover member and said lower cover member together to form an enclosure configured for holding the fill spout therein.

20. The cover of claim 19, including a cover face plate for covering the elongated opening defined by the upper cover member and the lower cover member.
